(19) United States
(12) Patent Application Publication
(10) Pub. No.: US 2025/0075719 A1
(43) Pub. Date: Mar. 6, 2025

(54) CABLE CRIMPING DEVICE

(71) Applicant: Bizhen ZHANG, Dongguan (CN)

(72) Inventor: Bizhen ZHANG, Dongguan (CN)

(21) Appl. No.: 18/754,242

(22) Filed: Jun. 26, 2024

Related U.S. Application Data
(63) Continuation-in-part of application No. PCT/CN2023/117295, filed on Sep. 6, 2023.

(51) Int. Cl. F16B 7/04

(52) U.S. Cl. CPC F16B 7/0413

(57) ABSTRACT

The cable crimping device of the present application comprises a cable locking screw rod and a screw rod receiving member screwed with the cable locking screw rod, wherein the cable locking screw rod comprises a threaded part and a cable cramp arranged at one end of the threaded part, and a clamping channel is arranged in the cable cramp; the cable crimping device further comprises a hollow locking member arranged between the cable cramp and the screw rod receiving member. With the cooperation of the cable locking screw rod, the screw rod receiving member and the locking member, the cable inserted into the cable cramp can be crimped, and the cable can be fixed on other objects through the screw rod receiving member without the need of other tools to crimp the end of the cable. The device is time-saving and labor-saving, reusable, energy-saving and environment-friendly.

### CROSS REFERENCE

This application is a continuation-in-part of International (PCT) Patent Application No. PCT/CN2023/117295, filed on Sep. 6, 2023, the entire contents of which are hereby incorporated by reference in their entirety.

### TECHNICAL FIELD

The present application relates to the technical field of cable assembly parts, in particular to a cable crimping device.

### BACKGROUND

Most cable connecting terminals in the market need to crimp a cable by applying a clamping pressure around all or part of the periphery of the cable with a crimping tool, which is cumbersome and time-consuming, and has the problem of a high cable installation cost.

Accordingly, it is necessary to design a new swageless cable crimping device to solve the above technical problems.

### SUMMARY

In order to solve the above problems, the present application provides a swageless cable crimping device, which is time-saving and labor-saving, reusable, energy-saving and environment-friendly.

Based on this, the present application provides a cable crimping device, which incudes a cable locking screw rod and a screw rod receiving member screwed with the cable locking screw rod, wherein the cable locking screw rod comprises a threaded part and a cable cramp arranged at one end of the threaded part, and a clamping channel is arranged in the cable cramp; the cable crimping device further comprises a hollow locking member arranged between the cable cramp and the screw rod receiving member.

Preferably, a length of the locking member is smaller than that of the cable locking screw rod, and an inner diameter of the locking member is larger than that of the threaded part, but smaller than that of the screw rod receiving member.

Preferably, the cable cramp comprises a plurality of tapered wedges arranged at intervals, and the tapered wedges surround to form the clamping channel.

Preferably, the tapered wedge is provided with clamping teeth inside for crimping a cable.

Preferably, a cross section of the tapered wedge in a direction perpendicular to the cable is a fan-shaped arc.

Preferably, a number of the tapered wedges is four, which are evenly spaced from each other and have a same size.

Preferably, the cable cramp is provided with external threads, and the locking member is provided with internal threads.

Preferably, an outer surface of the locking member is provided with a first clamping part, and an outer surface of the screw rod receiving member is provided with a second clamping part.

Preferably, the first clamping part is a pair of oppositely arranged clamping grooves, and the second clamping part is a pair of oppositely arranged planes.

Preferably, the screw rod receiving member comprises a screwing part screwed with the threaded part for partially accommodating the locking screw rod and a base part connected with the screwing part.

The cable crimping device of the present application includes a cable locking screw rod and a screw rod receiving member screwed with the cable locking screw rod, wherein the cable locking screw rod comprises a threaded part and a cable cramp arranged at one end of the threaded part, and a clamping channel is arranged in the cable cramp; the cable crimping device further comprises a hollow locking member arranged between the cable cramp and the screw rod receiving member. With the cooperation of the cable locking screw rod, the screw rod receiving member and the locking member, the cable inserted into the cable cramp can be crimped, and the cable can be fixed on other objects through the screw rod receiving member without the need of other tools to crimp the end of the cable. The device is time-saving and labor-saving, reusable, energy-saving and environment-friendly.

### BRIEF DESCRIPTION OF DRAWINGS

In order to explain the specific embodiment of the present application or the technical solution in the prior art more clearly, the drawings needed in the description of the specific embodiment or the prior art will be briefly introduced below. Obviously, the drawings in the following description are some embodiments of the present application. For those skilled in the art, other drawings can be obtained according to these drawings without creative work.

FIG. 1 is a combined schematic diagram of a cable crimping device provided by an embodiment;

FIG. 2 is an exploded schematic view of the cable crimping device provided by an embodiment; and

FIG. 3 is a cross-sectional view of the cable crimping device shown in FIG. 1 taken along line A-A.

### DESCRIPTION OF EMBODIMENTS

The technical solution of the present application will be described clearly and completely with reference to the attached drawings. Obviously, the described embodiment is part of the embodiments of the present application, but not all of the embodiments. Based on the embodiment of the present application, all other embodiments obtained by those skilled in the art without creative labor shall belong to the protection scope of the present application.

In the description of this utility model, it should be noted that if the terms “center”, “upper”, “lower”, “left”, “right”, “vertical”, “horizontal”, “inside” and “outside” appear, the indicated orientation or position relationship is based on the orientation or position relationship shown in the attached drawings, which is only for the convenience of describing this application and simplifying the description. In addition, the terms “first”, “second” and “third” are used for descriptive purposes only, and cannot be understood as indicating or implying relative importance.

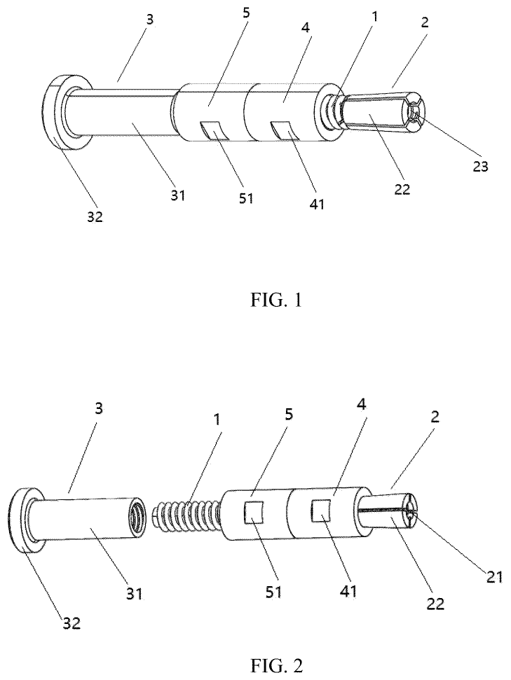

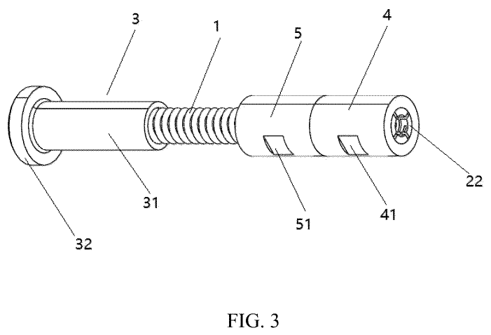

As shown in FIG. 1-FIG. 3, the present application provides a cable crimping device 100, which includes a cable locking screw rod 1 and a screw rod receiving member 2 screwed with the cable locking screw rod 1, wherein the cable locking screw rod 1 includes a threaded part 11 and a cable cramp 12 arranged at one end of the threaded part 11, a clamping channel 120 is arranged inside the cable cramp 12; and the cable crimping device 100 further includes a hollow locking member 3 arranged between the cable cramp 12 and the screw rod receiving member 2.

The screw rod receiving member 2 includes a screwing part 21 screwed to the threaded part 11 for partially accommodating the locking screw rod 1, and a base part 22 connected to the screwing part 21. Specifically, the screwing part 21 has a cylindrical shape and has internal threads matching with the threaded part 11. In this embodiment, the base part 22 is a screw, which is used to match with other parts to fix the screw rod receiving member 2 to an object with mounting holes. It can be appreciated that the base part 22 can also be a rivet or a nut with a diameter larger than that of the screwing part 21.

The length of the locking member 3 is smaller than that of the cable locking screw rod 1, and the inner diameter of the locking member 3 is larger than the diameter of the threaded part 11, but smaller than the diameter of the screw receiving member 2. Specifically, the inner diameter of the locking member 3 is smaller than the outer diameter of the screwing part 21, so that the locking member 3 abuts against the screwing part 21 and does not slide along the outer wall of the screw receiving member 2. The length of the locking member 3 is smaller than that of the cable locking screw rod 1, and the inner diameter of the locking member 3 is larger than the diameter of the threaded part 11, so that the locking screw 1 can pass through the locking member 3 to link the screw rod receiving member 2 and expose at least part of the cable clamp 12.

When the cable crimping device 100 is used to clamp a cable, the cable locking screw rod 1 can be taken out from the screw rod receiving member 2 first, and then the cable locking screw rod 1, the screw rod receiving member 2 and the locking member 3 are separated. When the cable is inserted into the clamping channel 120 of the cable cramp 12 of the cable locking screw rod 1, the cable cramp 12 is stretched by the cable, and the outer diameter of the cable cramp 12 becomes larger while the outer diameter of the threaded part 11 remains unchanged. The locking member 3 is sleeved on the cable locking screw rod 1 crimping the cable. Because the inner diameter of the locking member 3 is larger than the outer diameter of the threaded part 11, the threaded part 11 can pass through the locking member 3, but the cable cramp 12 crimping the cable cannot completely pass through the locking member 3, and will be contracted by the locking member 3 to crimp the cable. At this time, the threaded part 11 is screwed to the screwing part 21 of the screw rod receiving member 2. During the downward rotation of the threaded part 11 in the screwing part 21, the locking member 3 abuts against the screw rod receiving member 2, and cannot move downward with the cable locking screw rod 1, therefore it is crimped by the cable cramp 12 and the screw rod receiving member 2. In this way, finally, the locking member 3 firmly wraps the cable clamp 12, so that the cable clamp 12 can completely lock the cable. The assembly of cables on other objects can be completed by fixing the screw rod receiving member 2 to other objects.

When the cable needs to be removed, the screw rod receiving member 2 is first removed from other object, and the cable locking screw rod 1 or the screw rod receiving member 2 is rotated to loosen the threaded part 11 from the screwing part 21. At this time, the cable locking screw rod 1 moves upward relative to the screw rod receiving member 2, and the locking member 3 is loosened at the same time, so that the cable locking screw rod 1, the screw rod receiving member 2 and the locking member 3 are separated again, and the cable cramp 12 is not contracted by any external force, so that the cable inserted into the clamping channel 120 can be easily removed.

In this embodiment, the cable clamp 12 includes a plurality of tapered wedges 121 arranged at intervals, and the tapered wedges 121 surround to form the clamping channel 120. Specifically, the cross section of the tapered wedges 121 in the direction perpendicular to the cable is a fan-shaped arc, and the number of the tapered wedges 121 is four, which are evenly spaced from each other and have the same size. When the cable is inserted into the clamping channel 120, it is jointly clamped by the tapered wedges 121.

In an improved embodiment, the inside of the tapered wedge 121 is also provided with crimping teeth protruding to the clamping channel 120 for further crimping the cable.

Preferably, the cable clamp 12 is provided with external threads, and the locking member 3 is provided with internal threads matching with the external threads of the cable clamp 12, so that the cable clamp 12 can be screwed with the locking member 3 to tighten or release the tapered wedges 121 during the rotation of the cable clamp 12 relative to the locking member 3.

Further, the outer surface of the locking member 3 is provided with a first clamping part 31, and the outer surface of the screw receiving member 2 is provided with a second clamping part 23. In this embodiment, the first clamping part 31 is a pair of oppositely arranged clamping grooves, and the second clamping part 23 is a pair of oppositely arranged planes. The first clamping part 31 and the second clamping part 23 are convenient for users to operate crimping tools such as calipers to clamp the slender cable crimping device, and it is easy to make the locking member 3 and the screw rod receiving member 2 rotate relatively by rotating the crimping tools.

The cable crimping device of the present application includes a cable locking screw rod and a screw rod receiving member screwed with the cable locking screw rod, wherein the cable locking screw rod includes a threaded part and a cable cramp arranged at one end of the threaded part, and a clamping channel is arranged in the cable cramp; the cable crimping device further includes a hollow locking member arranged between the cable cramp and the screw rod receiving member. With the cooperation of the cable locking screw rod, the screw rod receiving member and the locking member, the cable inserted into the cable cramp can be crimped, and the cable can be fixed on other objects through the screw rod receiving member without the need of other tools to crimp the end of the cable. The device is time-saving and labor-saving, reusable, energy-saving and environment-friendly

The above embodiments are only used to illustrate, rather than to limit the technical solution of the present application; although the present application has been described in detail with reference to the above-mentioned embodiments, those skilled in the art should understand that it can still modify the technical solution recorded in the above-mentioned embodiments, or replace some or all of its technical features equally; however, these modifications or substitutions do not make the essence of the corresponding technical solution deviate from the scope of the technical solution of each embodiment of the present application.

What is claimed is:

1. A cable crimping device, comprising a cable locking screw rod and a screw rod receiving member screwed with the cable locking screw rod, wherein the cable locking screw rod comprises a threaded part and a cable cramp arranged at one end of the threaded part, and a clamping channel is arranged in the cable cramp; the cable crimping device further comprises a hollow locking member arranged between the cable cramp and the screw rod receiving member.

2. The cable crimping device according to claim 1, wherein a length of the locking member is smaller than that of the cable locking screw rod, and an inner diameter of the locking member is larger than that of the threaded part, but smaller than that of the screw rod receiving member.

3. The cable crimping device according to claim 2, wherein the cable cramp comprises a plurality of tapered wedges arranged at intervals, and the tapered wedges surround to form the clamping channel.

4. The cable crimping device according to claim 3, wherein the tapered wedge is provided with clamping teeth inside for crimping a cable.

5. The cable crimping device according to claim 3, wherein a cross section of the tapered wedge in a direction perpendicular to the cable is a fan-shaped arc.

6. The cable crimping device according to claim 3, wherein a number of the tapered wedges is four, which are evenly spaced from each other and have a same size.

7. The cable crimping device according to claim 1, wherein the cable cramp is provided with external threads, and the locking member is provided with internal threads.

8. The cable crimping device according to claim 1, wherein an outer surface of the locking member is provided with a first clamping part, and an outer surface of the screw rod receiving member is provided with a second clamping part.

9. The cable crimping device according to claim 8, wherein the first clamping part is a pair of oppositely arranged clamping grooves, and the second clamping part is a pair of oppositely arranged planes.

10. The cable crimping device according to claim 1, wherein the screw rod receiving member comprises a screwing part screwed with the threaded part for partially accommodating the locking screw rod and a base part connected with the screwing part.
